(19) United States
(12) Patent Application Publication
(10) Pub. No.: US 2016/0272280 A1
(43) Pub. Date: Sep. 22, 2016

(54) GEAR-CHANGE DEVICE FOR BICYCLES

(71) Applicants: Antonio Fernando CARDOSO, Itapeva - SP (BR); Elias Rodrigues DE SOUZA, Itapetininga - SP (BR)

(72) Inventor: Antonio Fernando CARDOSO, Itapeva - SP (BR)

(21) Appl. No.: 14/916,156

(22) PCT Filed: Aug. 14, 2014
(86) PCT No.: PCT/BR2014/000280

§ 371 Date: Jun. 6, 2016

(30) Foreign Application Priority Data
Sep. 3, 2013 (BR) 20 2013 022462-1

(51) Int. Cl. B62M 25/04

(52) U.S. Cl. CPC B62M 25/04

(57) ABSTRACT

The present subject matter relates to a speed-change device for bicycles, enabling the user to change gear sequentially, from the lowest to the highest combination, which allows the cyclist to pedal without a drop in cadence (revolutions per minute), without noticing a difference in load (speed increase) and without a reduction in the performance (reducing, diminishing speed) of his bicycle. The objective of the system (combinations, mechanism) gives the cyclist this correct sequence enabling him to save time and not to unnecessarily waste energy. The actual cyclist can be certain that the mechanism is implementing the correct sequence for him and that his pedalling performance will be the most advantageous.

This subject matter refers to a speed-shift device introduced in bicycles, allowing the user to shift gears sequentially, from the least powerful to the most powerful combination, preventing the cyclist from losing cadence (revolutions per minute) and from feeling the difference between loading (increase the speed) or releasing (reduce, lower the speed) his/her bicycle when cycling.

The objective of the system (combinations, mechanism) provides the cyclist with this correct sequence allowing him/her to gain time and preventing him/her from unnecessary tiring. The cyclist himself/herself being certain that the mechanism executes the correct sequence for him/her, getting the most out of his/her cycling performance.

For all the bicycle models (mountain bike, speed, spinning, ergometer, etc.) having a sets of gears with 10 to 33 speeds (combinations), and for sets of more combinations, so that the cyclist performs properly and is certain of being in the correct sequence (gear) important at a given time, enhancing his/her performance and facilitating the use of the bicycle (gear).

This subject matter aims to offer a greater practicality and ease to bicycle users in general, since it enables the user to shift gear without worrying about the combinations defining them.

Nowadays bicycles are equipped with a system of gears arranged in a set of “N” gears on the shaft hub of the rear wheel (k7) and “N” gears on the crankarm hub (where the pedals are fixed). Mechanisms (tensioners) fixed to these hubs move transversely with respect to the drive chain, engaging the (rear/front) gears and defining a speed ratio (gear). Tensioner motion is transmitted by cables connected to the throttle fixed to the handlebar and activated by the cyclist. These throttles have a locking system that positions the drive chain on the gear defined as “ideal”. Each set of gears (rear hub/crankarm hub) is activated by a throttle equipped with two levers for each hand. A lever to move the drive chain toward the gear with the highest number of teeth, locking it to each gear in sequence. The other lever performs the reverse process, relieving the locking system, the tensioner moving the drive chain toward the gear with fewer teeth.

When a cyclist is cycling, that is, producing cadence (revolutions per minute)—whatever that may be—he/she cannot perform the exact sequential combination from the first lighter gear to the last heavier gear.

Nowadays all the gear bicycles have several speeds (combinations) from 10 to 33 speeds (combinations); however cyclists engage these speeds randomly, without being sure of being in the correct sequence to enhance their own performance and facilitate the use of the bicycle gear.

The subject matter developed herein enable the cyclist to perform this correct sequence to enhance his/her performance easily, without loss of time and without wearing out. With a throttle in each hand, pressing the left throttle with the coupled device will increase (loading) the speed and t right lever, while pressing the right throttle will produce relieve and reduce the speed.

### STATE OF THE ART

In order to launch a unique product on the market, a prior art search was conducted based on the Brazilian PTO Database and the following patents were found:

P18307339-6, filed on Dec. 29, 1983, “Gearbox, drive and support system for auxiliaries in bicycles”.

Three subset consisting of: a) gearbox with neutral, power gear and speed gear; b) drive system by pinion, chain and sprocket or toothed pulleys and toothed belt(s) pulling the rear wheel of bicycles having auxiliary motors; and c) adjustable support for fixing the fuel tank and the auxiliary motor on conventional bicycles of any size.

P10803318-8, filed on Aug. 20, 2008 “2×2 supine traction bicycle”. This patent refers to a complement for bicycles, said complement adding a set of gears coupled on a fixed support of the arms on the bicycle front, which transmits the mechanical traction generated by the force applied by the cyclist on the handlebars or the bar in continuous motion forward and rearward, producing the continuous operation of the gears, wherein, when said complement is not activated by the cyclist, the bicycle presents its normal operation. Nowadays, the technological advance has made possible the addition of drive gears in bicycles, reducing the physical effort of the cyclist. In order to add a novel operational alternative to bicycles it was developed the instant invention, which does not change its initial operation when the system is not activated. The attached drawings show four operational models of bicycle 2×2 supine traction mechanism aiming to fulfill the needs of those cyclists looking for novelties. The saddle (1) has a rear projection. It supports the cyclist when he/she drives the special handlebar (10) or the slider (47) forward, wherein said movement projects the lumbar part rearward by inertia, thus receiving the support of the projection of the of the saddle (1) and gaining strength to drive the slider (47) and the handlebar (10) with the arm. The support seat (4) is extremely necessary to stabilize the cyclist's chest when he/she pulls the slider (47) and the special handlebars toward his/her chest. The support seat and is a saddle extension with flexibility due to a hinge to better adjust its height for the cyclist. The spring (21) housed in the front bar (44) is a novel damping system for bicycles which aims to dampen impacts in the chest area. Hinge (20) works together with support hinge (76) in order to keep still the supporting area (13) bearing the spring (21). A bicycle ordinary handlebar (8) presents a tube-shaped extension with a spring (78) fitting in the upper edge of the structure of the support for the mechanism of the bicycle 2×2 traction mechanism (65) with the aim to support the structure (65) accompanying the movement of the front suspension (77). The bicycle frame has double tubes (movably embedded) adjustable by means of fasteners (79) whose function is to adjust the distance between the cyclist and the special handlebar (10) and also the one between the cyclist and the bar handle (47).

PI0503228-8, filed on Jul. 29, 2005 “Bicycle gear operating device”. This invention refers to an operating device for gear-shift in a bicycle, including a first gear-shift operation component, a second gear-shift operation component and a drive control mechanism. The first gear-shift operation component is coupled in an articulated fashion to a first articulating shaft to rotate around said first articulation shaft and to move along a first gear-shift plan that is perpendicular to said first articulating shaft. The second gear-shift operation component is coupled in an articulated fashion with a second articulating shaft to move along a second gear-shift plan that is perpendicular to the second articulating shaft and crosses the first gear-shift plan forming an angle equals to or lower than 30 degrees between the first and the second gear-shift plans. The drive control mechanism is configured to control transmission in a bicycle. The drive control mechanism is coupled in an operational way with the first and second gear-shift operation components.

P11000949-3, filed on Mar. 26, 2010, “Improvements introduced in bicycle sprocket in general”. These improvements are analogous to those used in crankarm and similar apparatuses involving gear-shift such as in bicycles having 10, 18, 24 gears or others, wherein, more particularly, the improvements relate to the fact that each sprocket (1) of the drive system (ds) has at least one oblique groove (2) whose purpose is to enable a smooth gear-shift and, if it has three (03) grooves, to enable the shift to take place with only ⅓ revolution with the help of a shifter (s) with no risk of the chain getting entangled or skipping, thus performing a smooth gear-shift.

PI0602796-2, filed on Jul. 18, 2006, “Control mechanism of gear-shift position of bicycles”. This invention refers to a control mechanism of gear-shift position of bicycles that is configured to provide a gear-shift unit for bicycles with multiple gear shifts in a single acceleration operation or in a single deceleration operation. The control mechanism of gear-shift position has a wire stretching component, a positioning component, a first position-maintaining component and a second position-maintaining component. The positioning component revolves together with the wire stretching component between one among a plurality of predetermined gear-shift positions. The first position maintaining component selectively moves between a first engaging position that maintains the positioning component in one of the predetermined gear-shift positions and a first disengagement position that releases the positioning component resulting into a rotary motion. The second position maintaining component selectively moves between a second engaging position that maintains the positioning component in one of the predetermined gear-shift positions and a second disengagement position that releases the positioning component resulting into a rotary motion.

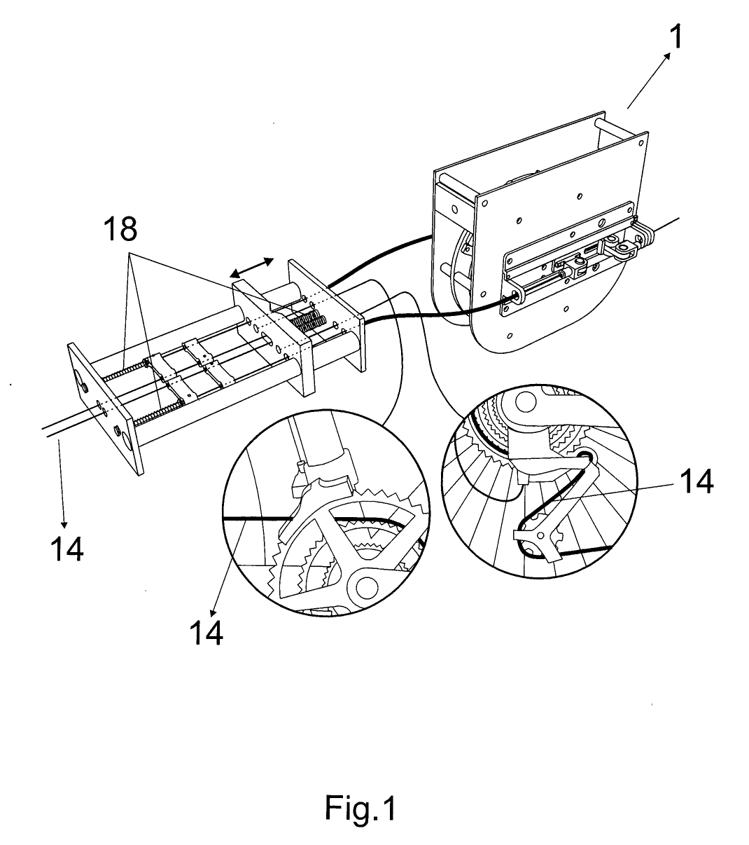

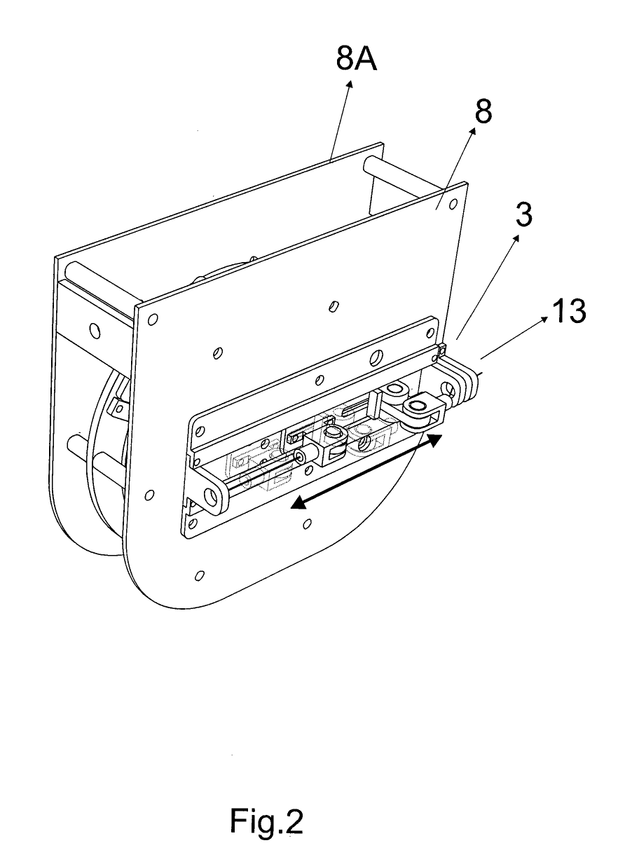

MU8501128-2, filed on Jun. 14, 2005 “Bicycle gear-shift”. It consists of a protective box (11)—whose front view is shown in FIG. 2—which contains—according to FIG. 1—the main shaft (1) presenting the pedals (1 and 2) at its ends and the fixed gear in its body (4), the fixed gear being responsible for the engagement of the first gear, and the large gear (5) being responsible for the engagement of the second gear. The secondary shaft (6) has three gears on its fixed body, wherein the engagement of the large shifting gear (8) with the fixed gear (4) of the first shaft (1) will result in the first gear; the engagement of the large shifting gear (9) with the large gear (5) of the first shaft (1) will result in the second gear, complementing with one more fixed connection gear (12) intended to be connected to the fixed gear (14) of the third shaft. The third shaft (13) consists of a sprocket (07) that will be responsible to receive the connection chain for the chain of bicycle rear wheel, transmitting the wheel rotary motion resulting in the movement of the bicycle. The martins bicycle gear-shift still presents an engagement fork (10) in the shifting gears to shift gears.

According to the foregoing summaries, the mentioned processes are not similar to the process subject matter of this patent and, thus, we believe that there are neither technical nor legal impediments hindering the grant of the requested protection.

The product discloses herein describes several benefits, including greater practicality, convenience and diversification with large industrial feasibility, low cost and numerous innovations that deserve this patent protection.

For an optimal visualization and understanding of the “DEVICE INTRODUCED IN BICYCLES” in question please check the following illustrative drawings, wherein:

FIG. 1—Shows a perspective view with close-ups detailing the gear-shift object in question;

FIG. 2—Shows a perspective view of the object in question;

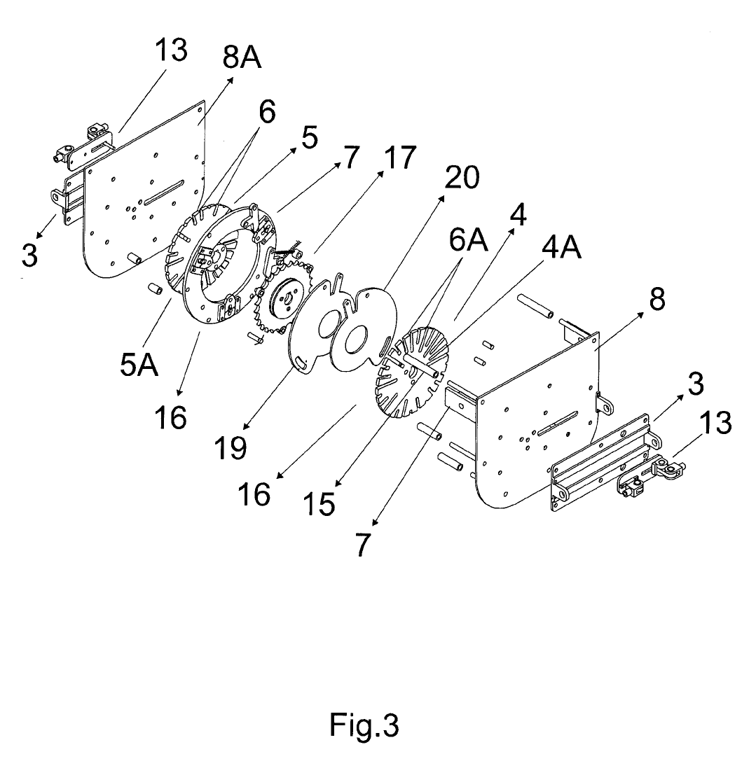

FIG. 3—Shows an exploded view of the object in question;

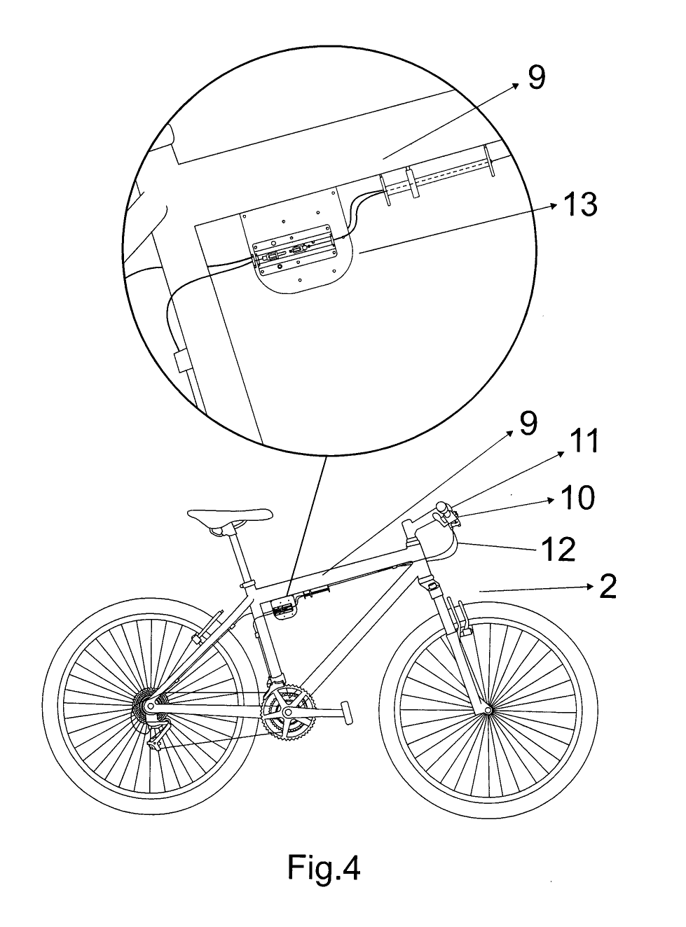

FIG. 4—Shows an illustrative view of the object in question with a close-up of the object in question.

According to the illustrations and their details, said “DEVICE INTRODUCED IN BICYCLES” is characterized in that it comprises a gear-shift mechanism (1) for bicycles (2) having a mechanism (3) with two devices each of one having 27 radial channels, K7 (4) and crankarm (5) provided with three measures for the length of the channels (6), disc K7 (4) containing nine different measures for the length of the channels (6A); with discs (4-5) installed on a shaft (7), performing simultaneous actions combining a gear of K7 (4A) with a gear of the crankarm (5A) to define the gear; the mechanism (3) further having (3) closing plates (8-8A) to be installed on the frame of the bicycle (9), activated by two levers (10-11) installed on the handlebars (12), provided with a shifting system (13) fixed to each side of the mechanism (3), performing a link (14) between the levers (10-11) and the sets of gears (4-5) through a cable; the locking pins (15) moving linearly, placing themselves within the channels of the discs (6-6A).

The forward motion of the shifting system (13) is performed by the lever (10-11) and, upon release, the tensioner (16) placed in sets K7 (4) and crankarm (5) causes it to return to the rest position and the locking pin (15) limiting the stroke depending on the length of the placed channel (6-6A).

Upon activation of the right lever (10), the disc (4-5) revolves clockwise with a lower strength ratio from the 1^{st} to the 27^{th} gears. As for the opposite direction, upon activation of the left lever (11) the disc rotates anti-clockwise with a higher strength ratio. Each position of the discs is defined by a turnstile mechanism that rotates until the degree necessary for each ratio (gear), locking in the expected position. Thus, the mechanism allows an intelligent sequence of the ratio (gears of K7/gears of the crankarm) by a simple action on the right lever (relieving) and left lever (loading). The mechanism is adjustable to the different existing types of speeds from 10 to 33 combinations for sets of more numerous combinations.

Due to both the advantages that it provides and to its truly innovative characteristics the “DEVICE INTRODUCED IN BICYCLES”, meets the necessary conditions to deserve protection as a Utility model.

1. A DEVICE INTRODUCED IN BICYCLES characterized in that it comprises a gear-shift mechanism (1) for bicycles (2) having a mechanism (3) with two devices each of one having 27 radial channels, K7 (4) and crankarm (5) provided with three measures for the length of the channels (6), disc K7 (4) containing nine different measures for the length of the channels (6A); with discs (4-5) installed on a shaft (7), performing simultaneous actions combining a gear of K7 (4A) with a gear of the crankarm (5A) to define the gear; the mechanism (1) further having a storage box (8) to be installed on the frame of the bicycle (9), activated by two levers (10-11) installed on the handlebars (12), provided with a shifting system (13) fixed to each side of the mechanism (3), performing a link (14) between the levers (10-11) and the sets of gears (4-5) through a cable; the locking pins (15) moving linearly, placing themselves within the channels of the discs (6-6A).

2. The DEVICE INTRODUCED IN BICYCLES according to claim 1 and characterized in that the forward motion of the shifting system (13) is performed by the lever (10-11) and, upon release, the tensioner (16) placed in sets K7 (4) and crankarm (5) causes it return to the rest position and the locking pin (15) limits the stroke depending on the length of the channel (6-6A).

3. The DEVICE INTRODUCED IN BICYCLES according to claim 1 and characterized in that, upon activation of the right lever (10), the discs (4-5) revolves clockwise with a lower strength ratio from the 1^{st} to the 27^{th} gears; upon activation of the left lever (11) the discs (4-5) revolves anti-clockwise with a higher strength ratio; turnstile being present in the mechanism, which rotates until achieving the degree necessary for each ratio (gear), locking in the expected position; compressing springs (18) allow the cable (14) to move forward and backward according to the activation of discs of headway devices in order to decrease (19) and increase (20) the revolution.
